(19) United States
(12) Patent Application Publication
(10) Pub. No.: US 2021/0395002 A1
(43) Pub. Date: Dec. 23, 2021

(54) MOUNTABLE HANGING HOPPER FOR GRAIN BIN

(71) Applicant: Craig LINDHOLM, New Norway (CA)

(72) Inventor: Craig LINDHOLM, New Norway (CA)

(21) Appl. No.: 17/352,142

(22) Filed: Jun. 18, 2021

Related U.S. Application Data
(60) Provisional application No. 63/041,042, filed on Jun. 18, 2020.

(30) Foreign Application Priority Data
Jun. 18, 2020 (CA) 3084212

(51) Int. Cl. B65D 88/28; A01F 25/20

(52) U.S. Cl. CPC B65D 88/28; A01F 25/2018

(57) ABSTRACT

In one aspect there is provided a hopper, for use with a grain bin having a gate assembly with bolts or flanged edges. The hopper comprises a concave shape, a bottom, and hopper walls forming a chamber with an open top for receiving granular materials from the gate assembly. A mounting member is positioned on the hopper walls adjacent the open top to mount the hopper from the gate assembly's bolts or flanged edges.

### CROSS REFERENCE TO RELATED APPLICATION

This application is a non-provisional application which claims priority to, and benefit of, U.S. Provisional Patent Application Ser. No. 63/041,042 filed Jun. 18, 2020 and entitled, “MOUNTABLE HANGING HOPPER FOR GRAIN BIN”, the entirety of which is incorporated herein by reference.

### FIELD OF THE INVENTION

This invention relates generally to grain bin accessories. More particularly, the invention relates to a hopper mountable to a grain bin.

### BACKGROUND OF THE INVENTION

The background information discussed below is presented to better illustrate the novelty and usefulness of the present invention. This background information is not admitted prior art.

Silos and bins are structures commonly used to store bulk materials. In agriculture, they are typically used to store grain or fermented feed known as silage. Silos and bins may also be used to store other granular materials, such as coal, cement, woodchips and sawdust. A bin is typically much shorter than a silo and may be used for holding matter such as cement or grain. Grain is often dried in a grain dryer before being stored in a bin. Bins may be round or square, but round bins tend to empty more easily due to a lack of corners for the stored material to become wedged and encrusted.

Due to the dry nature of the stored grain in a bin, it tends to be lighter than silage and can be more easily handled by under-bin grain unloaders. To facilitate such under-bin unloading, grain bins may be raised by legs spaced around their bottom perimeter, and be provided with a hopper bottom cone assembly (sometimes referred to as a “cone”) which funnels the bin's content to a centralized opening or throat. A slide gate assembly may be provided at the throat, to allow an operator to selectively open or close the throat.

During bin unloading, the slide gate assembly of the throat is actuated to the open position, and the bin's contents (typically dried grain) will fall due to gravity into the space below the cone. Screw conveyor or augers are typically employed to receive the free-flowing granular materials exiting from the bin, and then move, evacuate or elevate such materials to another destination, such as a grain truck or other storage bin. A hopper may be placed underneath the bin to assist with the transfer of the granular material into the auger, i.e. by collecting the free-flowing granular materials into its interior volume, for subsequent removal therefrom by the auger.

One example of a grain hopper is disclosed in U.S. design Pat. No. 279,323. That hopper is generally concave, having hopper walls forming a chamber with an open top for the receiving granular materials and directing them downward along the incline of the walls to the bottom of the hopper. That hopper further comprises a semi-circular rest at one end for conforming to, and for supporting, an auger that may be placed within the hopper's chamber.

However, such conventional hoppers have problems. In particular, granular materials tend to spill over, such as when the rate of free-flowing granular materials exiting the bin exceeds the rate at which an auger can evacuate materials therefrom. Therefore, what is needed is a hopper that does not suffer from such disadvantages, while still retaining simplicity of design and portability (e.g. between different grain bins).

### BRIEF DESCRIPTION OF THE DRAWINGS

Referring to the drawings, several aspects of the present invention are illustrated by way of example, and not by way of limitation, in detail in the figures, wherein:

FIG. 1 is a perspective view of one embodiment of a hopper for a grain bin, shown in a fully mounted configuration hanging from the grain bin;

FIG. 2 is another perspective view of the hopper of FIG. 1, shown in the fully mounted configuration hanging from the grain bin;

FIG. 3 is a top perspective view of the hopper of FIG. 1;

FIG. 4 is a front perspective view of the hopper of FIG. 1;

FIG. 5 is a rear perspective view of the hopper of FIG. 1;

FIG. 6 is a side perspective view of the hopper of FIG. 1;

FIG. 7 is a bottom perspective view of the hopper of FIG. 1;

FIG. 8 is a front perspective view of the hopper of FIG. 1, showing one embodiment of a mounting member;

FIG. 9 is a front perspective view of the hopper of FIG. 1, showing the mounting member;

FIG. 10 is a rear perspective view of the hopper of FIG. 1, showing the mounting member;

FIG. 11a is a front perspective view of the hopper of FIG. 1, shown in the fully mounted configuration on the gate assembly;

FIG. 11b is a front perspective view of the hopper of FIG. 1, shown in a partially mounted configuration on the gate assembly;

FIG. 12 is a perspective view of the hopper of FIG. 1, showing in a fully mounted configuration on bolts of the gate assembly;

FIG. 13 is a side perspective view of the hopper of FIG. 1, shown in a fully mounted configuration on the bolts of the gate assembly;

FIG. 14 is a rear perspective view of the hopper of FIG. 1, shown in a partially mounted position on the bolts of the gate assembly;

FIG. 15 is a rear close-up perspective view of the hopper of FIG. 1, shown in a fully mounted configuration on the bolts of the gate assembly;

FIG. 16 is a side perspective view of mounting member of the embodiment of the FIG. 8, shown in an initial, partially mounted position on the bolts of the gate assembly;

FIG. 17 is a side perspective view of the mounting member of FIG. 8, shown in a fully mounted configuration on the bolts of the gate assembly;

FIG. 18 is a close up perspective view of the mounting member of FIG. 8, shown in a fully mounted configuration on the bolts of the gate assembly;

FIG. 19 is a perspective view of the mounting member of FIG. 8, shown in a fully mounted configuration on the flanges of the gate assembly;

FIG. 20 is a perspective view of the hopper of FIG. 1, shown in a fully mounted configuration on the flanges of the gate assembly;

FIG. 21 is a side perspective view of the hopper of FIG. 1, shown in a fully mounted configuration on the flanges of the gate assembly; and

FIG. 22 is a series of side perspective views of the hopper of FIG. 1, shown being positioned by an operator from an unmounted position, to a partially mounted configuration, to a fully mounted configuration hanging from the flanges of the gate assembly.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

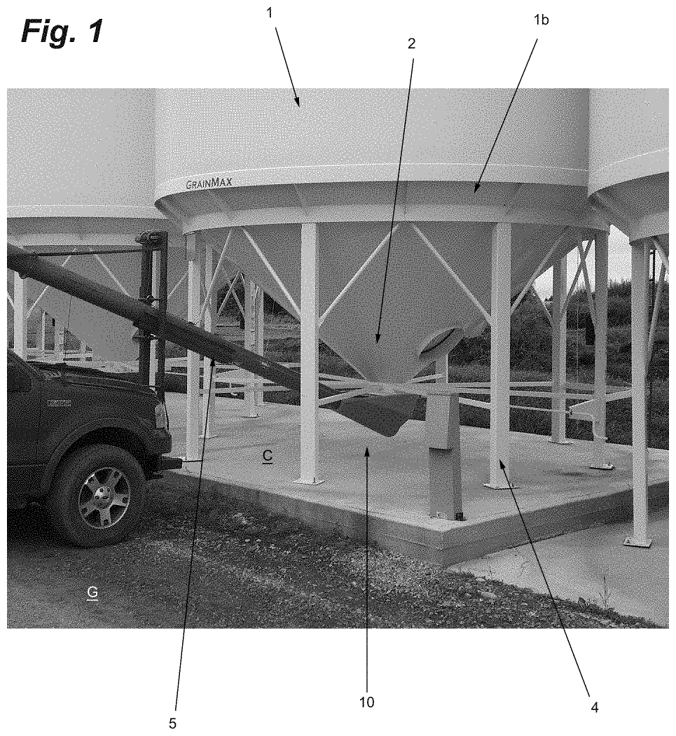

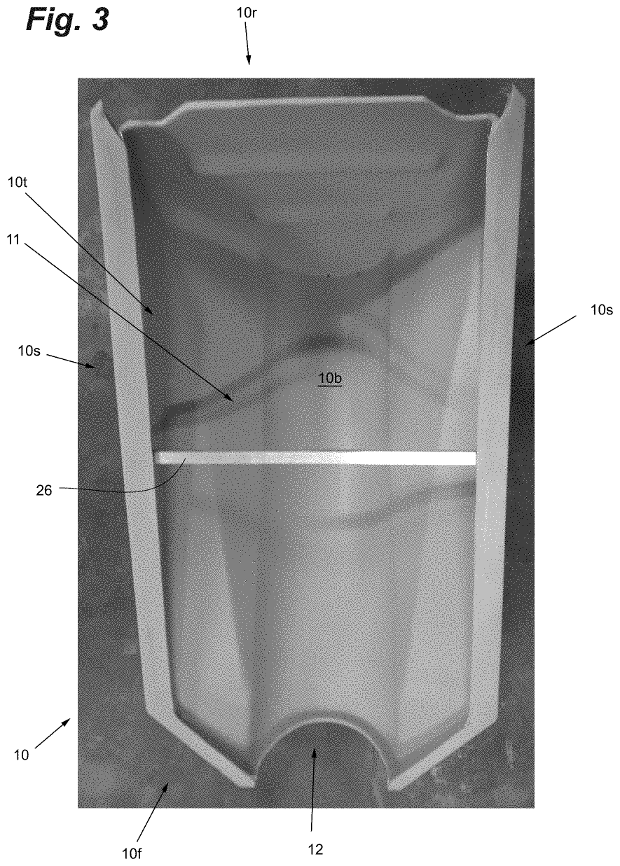

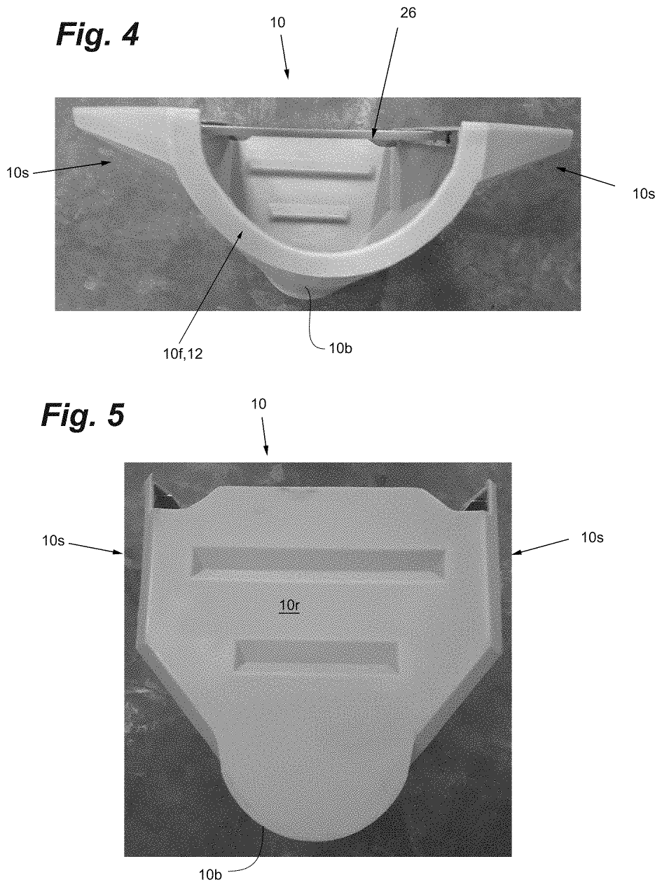

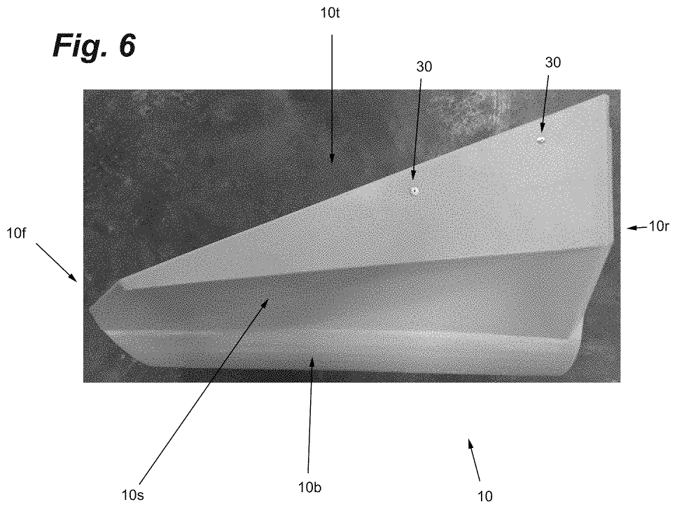

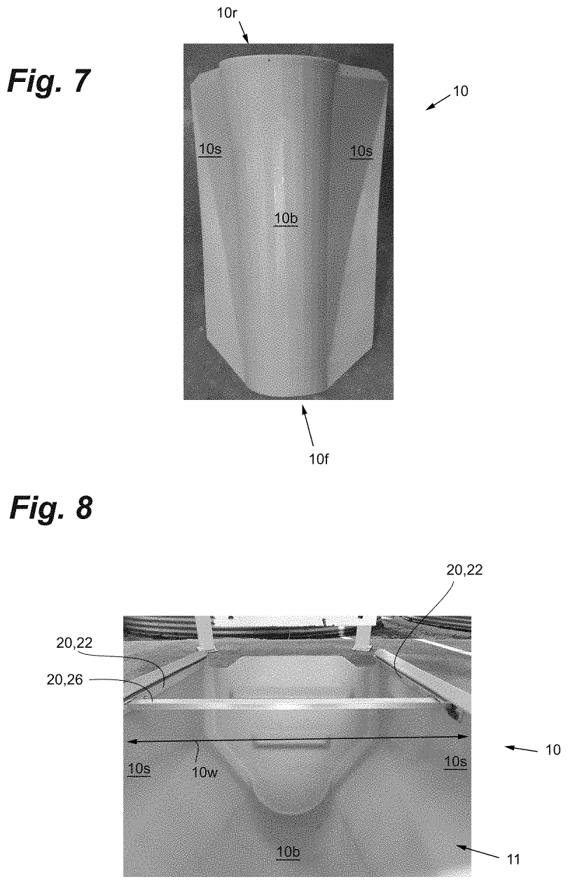

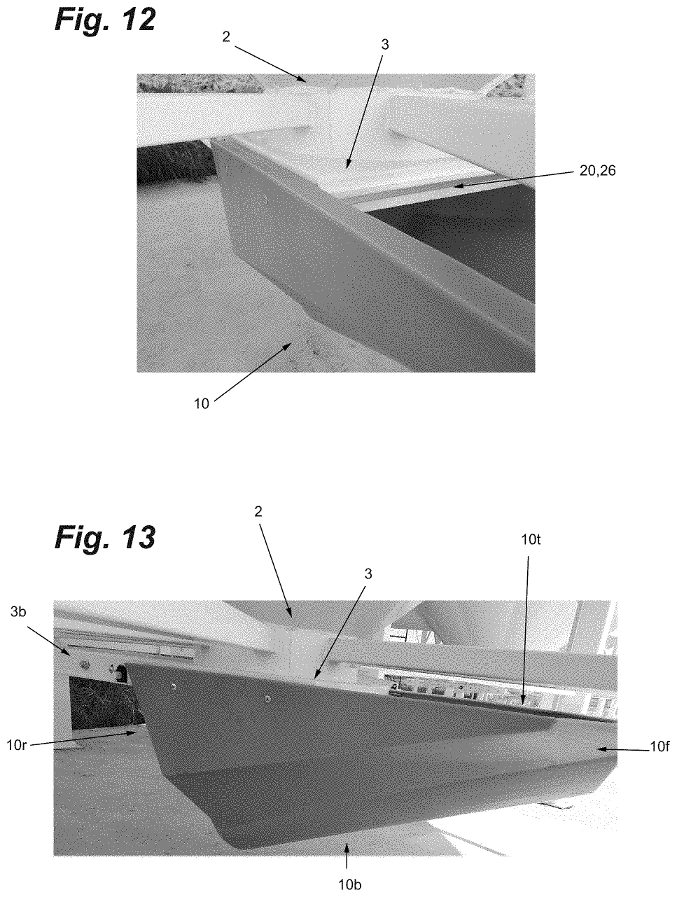

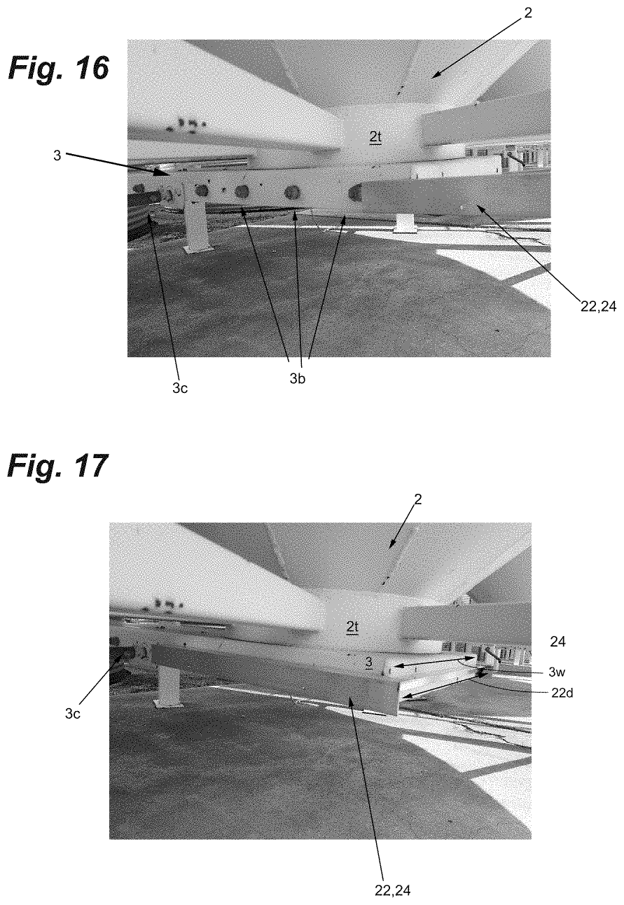

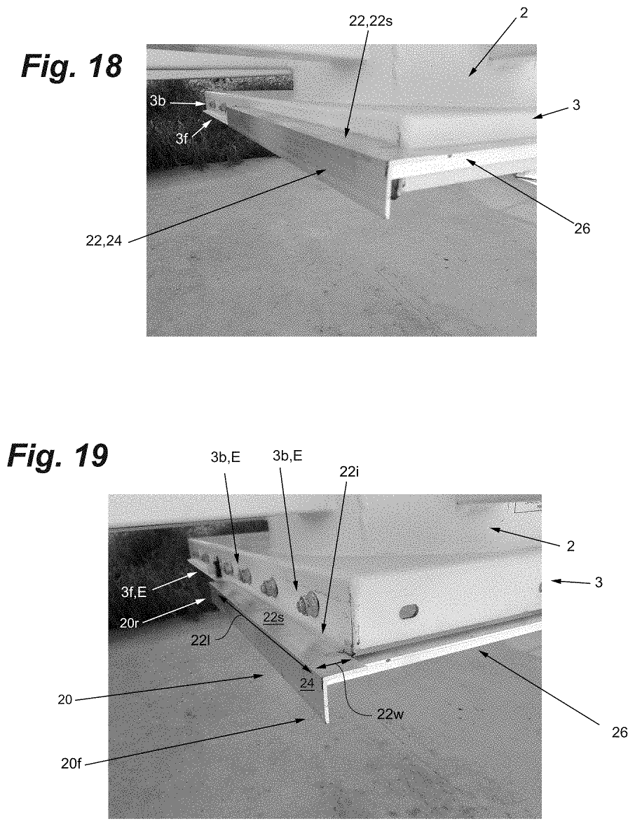

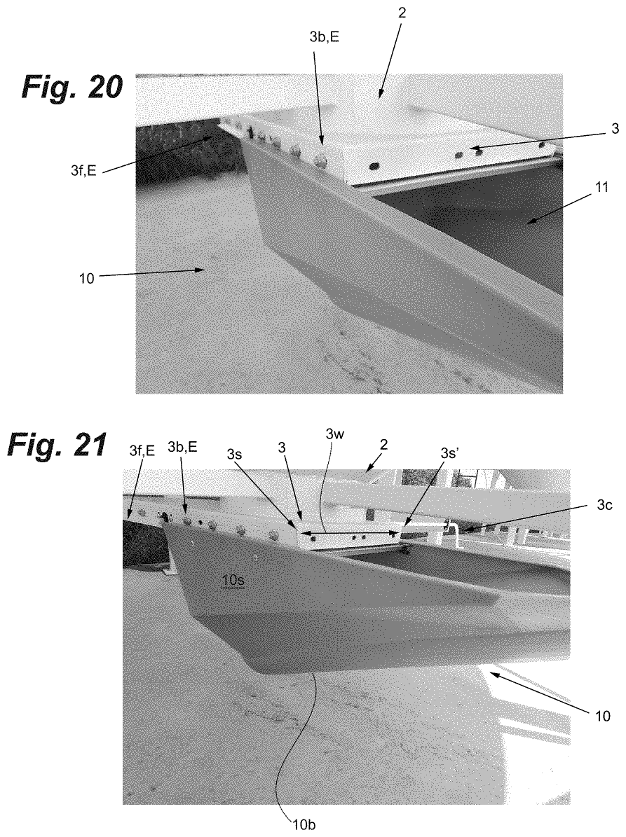

A first embodiment of the hopper 10 of the present invention is shown in FIGS. 1-22. The hopper 10 is designed to be used with a bin 1 having a hopper bottom cone assembly 2 at the bin's bottom end 1b. The bin 1 and hopper bottom cone assembly 2 are preferably mounted above a surface such as the ground G or a concrete pad C in a conventional manner using legs 4 or other supports. The hopper bottom cone assembly 2 will typically have a throat 2t with an opening to allow granular material (e.g. grain) to exit out of the bin 1 in a conventional manner.

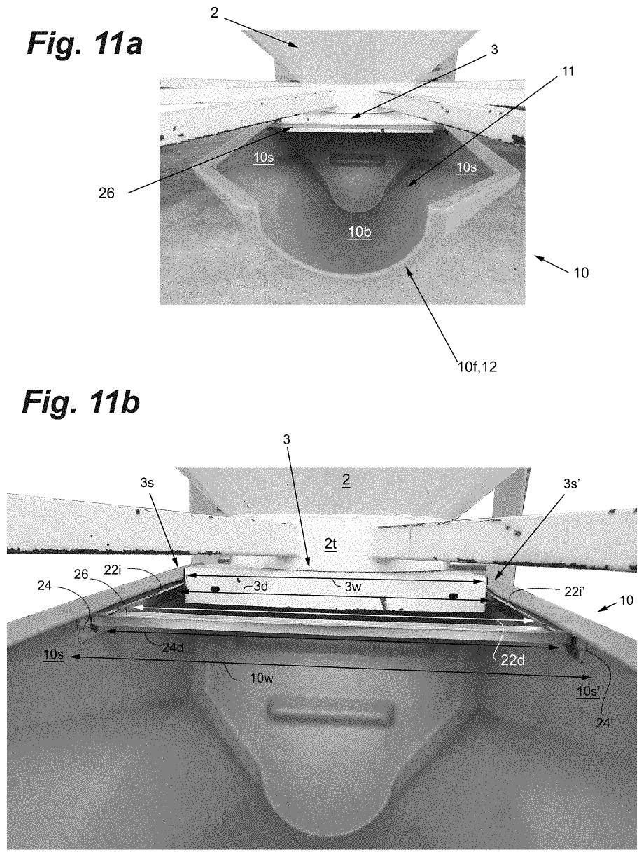

A gate assembly 3 is preferably provided at the throat 2t, to allow an operator to selectively open or close the throat's opening, such as by actuating the gate assembly 3 using a crank 3c. On many bins, the gate assembly 3 will typically further comprise lateral projections such as bolts 3b on either side 3s, 3s′ (e.g. to mount the gate assembly 3 to the throat 2t) and/or flanged edges 3f on either side 3s, 3s′ (e.g. see FIGS. 13-22). As such, the gate assembly 3 will have a width 3w (from side 3s to side 3′), and beyond which the ends E of said lateral projections (e.g. bolts 3b or flanged edges 3f) will project distally therefrom. The distance 3d between the ends E of the lateral projections (e.g. bolts 3b or flanged edges 3f) projecting distally from the sides 3s, 3s′ will therefore be greater than the width 3w from side 3s to side 3s′ (see FIG. 11b). This distance 3d may be referred to as a first distance or lateral projection distance. Preferably, the hopper 10 is mounted to, or suspended from, the gate assembly's bolts 3b and/or flanged edges 3f as further described below.

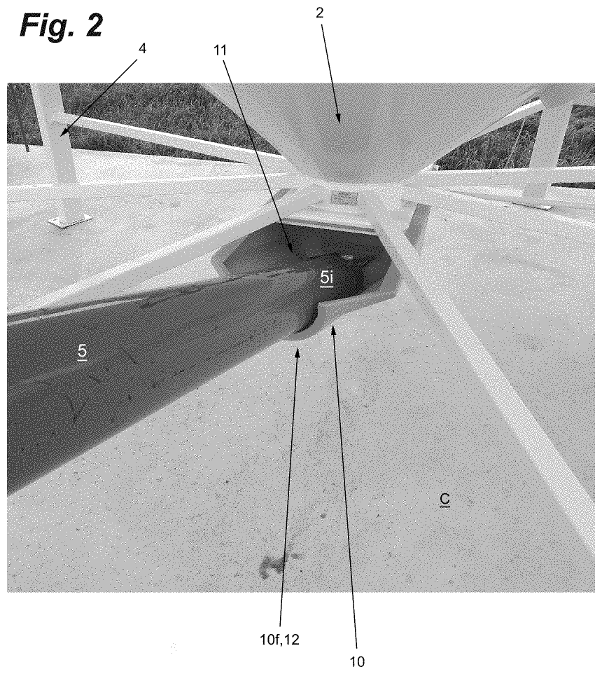

The hopper 10 of the first embodiment is generally concave, having hopper walls 10s forming a chamber 11 with an open top 10t for receiving granular materials and directing any such granular material downward along the decline (sloped configuration) of the walls' 10s interior to collect on the hopper's bottom 10b. The hopper 10 preferably further comprises a first or front end 10f, and a second or rear end 10r. As is conventional, the hopper's chamber 11 is suitable to receive the inlet end 5i of a screw conveyor or auger 5 (see FIG. 2). Removal or evacuation of any granular material from the hopper's chamber 11 can then accomplished via the screw conveyor 5 in a conventional manner.

Preferably, the hopper wall 10s further comprises a semi-circular rest 12 at the front end 10f for conforming to, and for supporting, an auger 5 through the open top 10t of the hopper 10, with the auger's inlet 5i placed within the chamber 11 (see FIGS. 2-4). More preferably, the hopper's bottom 10b is sloped into a sloped configuration so that, when mounted or suspended from the gate assembly 3, granular material will move and accumulate on the bottom 10b adjacent the rear end 10r (see FIG. 1). The sloped configuration facilitates removal of granular materials from the chamber 11 by the screw conveyor's inlet end 5i. Even more preferably, the hopper walls 10s and bottom 10b are produced from polyethylene (or some other type of thermoformed or rotomolded thermoplastic) as a single moulded piece in a conventional manner.

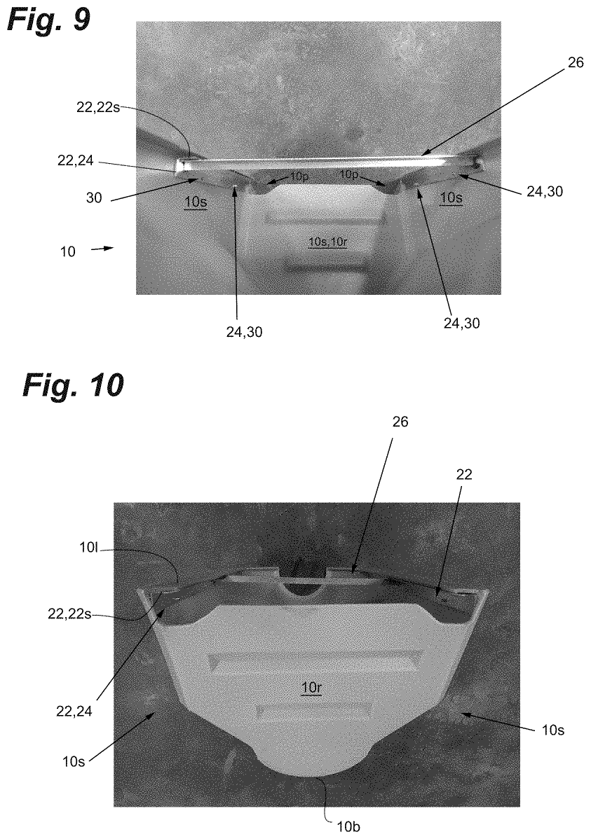

The hopper 10 further comprises a mounting member 20 positioned on the hopper walls 10s adjacent the open top 10t. The mounting member 20 mounts and/or suspends the hopper 10 from the gate assembly's bolts 3b and/or from the flanged edges 3f. In the embodiment of FIGS. 1-22 the mounting member 20 comprises a front end 20f, a rear end 20r and two side members 22. The two side members 22 are each positioned along generally opposite facing and parallel oriented sections of the hopper wall 10s (see FIGS. 8-9). Preferably, the two side member 22 are positioned on these hopper walls sections, adjacent the open top 10t, and substantially towards the rear end 10r of the hopper 10, i.e. so as to leave the front end 10f of the open top 10t substantially unobstructed by the gate assembly 3 when the hopper 10 is mounted or placed thereon (see FIG. 11a). Advantageously, by mounting the rear end 10r of the hopper 10 to the gate assembly 3, and leaving the open top 10t unobstructed at the front end 10f, the inlet end 5i of an auger 5 can still be easily positioned within the chamber 11 when the hopper 10 is mounted to the gate assembly 3 (see FIG. 2).

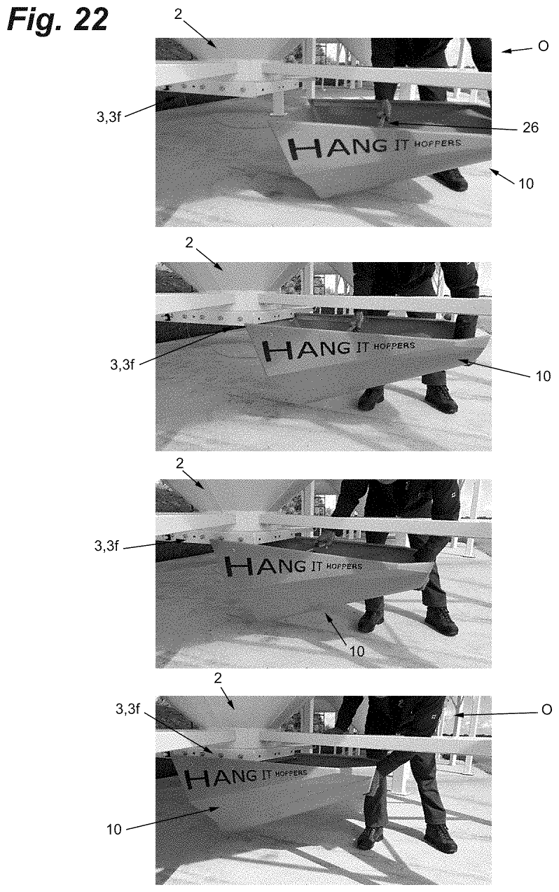

The side members 22 are preferably maintained in a spaced relation or distance from each other by spacing or cross member 26 (see FIGS. 8-12, and 18-19), thereby defining a width 10w within the chamber 11, i.e. the distance spanning between the two generally opposite facing hopper wall 10s sections (see FIG. 8). Advantageously, cross member 26 can also function as a handhold for an operator O moving the hopper 10 to the mounted configuration (see FIG. 22). More advantageously, cross member 26 can be positioned at a predetermined location (i.e. between front end 10f and rear end 10r), to cause it to bump or butt against the gate assembly 3 when the hopper 10 is in the mounted configuration (see FIGS. 11a, 12 and 18), thereby acting as an indicator to an operator O that the hopper 10 is indeed in the mounted configuration.

In another embodiment (not shown), the mounting member 20 comprises two side members 22 which are maintained in a spaced relation or distance from each other by the hopper walls 10s, but wherein no cross member 26 is provided. In yet another embodiment (not shown), the side members 22 are moulded as an integral part of the hopper, e.g. as part of the hopper's wall 10s.

In the embodiment of FIGS. 1-22 each side member 22 further comprises a support lip or shoulder 22s and a sidewall mounting member 24. In a preferred embodiment, the side member 22 may be constructed from a section of angle iron, or aluminum iron, having an L-shaped cross section defined by two legs, with one leg forming the shoulder 22s and the other leg forming the sidewall mounting member 24. In the embodiment of FIGS. 1-22 the sidewall mounting members 24 facilitates connecting the two side members 22 to the hopper's polyethylene wall 10s, such as by means of a rivet 30 or similar fastener. The sidewall mounting members 24 are preferably riveted to the generally opposite facing and parallel oriented sections of the hopper wall 10s at a distance 24d apart from each other, within the width 10w of the interior chamber 11 (see FIG. 11b). This distance 24d may be referred to as a second distance 24d or mounting member distance 24d.

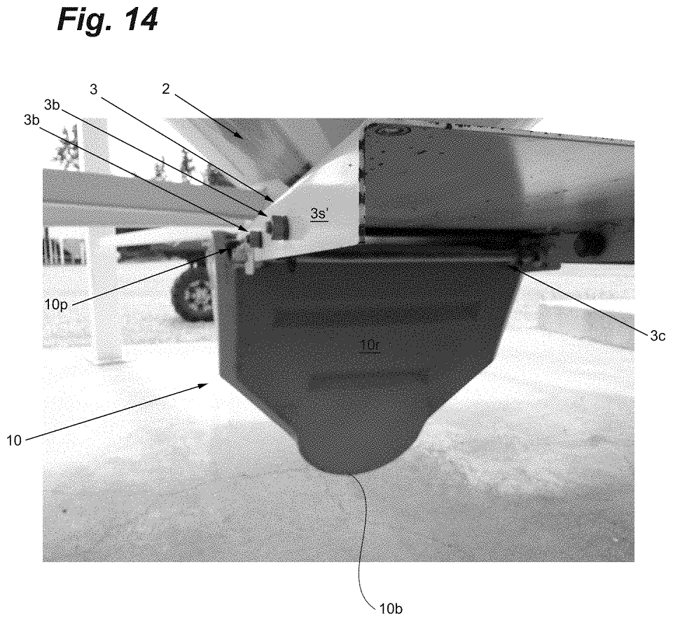

The shoulders 22s of the side members 22 each have a length 221 and a width 22w. When the hopper 10 is in a mounted configuration, said shoulder 22s can be placed or mounted upon at least some of the lateral projections (e.g. bolts 3b and/or the flanged edges 3f), along at least part of the length 221 and width 22w (see FIGS. 14-21); the shoulders 22s thereby supporting the weight of the hopper 10 (and any granular materials and/or auger inlet 5i placed therein) when mounted from the gate assembly 3 above the ground G. As can be seen, the shoulders 22s will further comprise an inner edge 22i, 22i′ (e.g. at the terminus of the angle iron's leg 22s). These paired opposing inner edges 22i, 22i′ of the side members 22 (mounted to generally opposite facing and parallel oriented sections of the hopper wall 10s) will then further define an inside clearance distance 22d therebetween (see FIGS. 11b and 17). This inside clearance distance 22d will be less than the first distance 3d between the ends E of the bolts 3b or ends E of the flanged edges 3f, so as to allow the mounting member 20 to rest upon the bolts 3d and/or flanged edges 3f when in the mounted configuration. However, the inside clearance distance 22d will be greater than the width 3w of the gate assembly 3, so as to allow the mounting member 20 to clear both sides 3s, 3s′ of the gate assembly 3 and mount on the bolts 3d and/or flanged edges 3f.

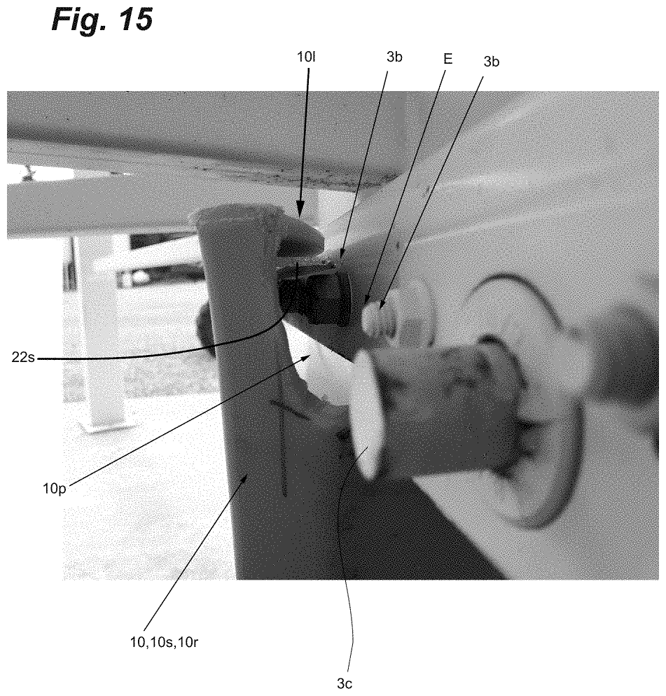

Preferably, the rear portions of the hopper side walls 10s (i.e. at the rear end 10r) will have sufficient clearance, openings and/or passages 10p to facilitate mounting and removal of the hopper 10 on/off the gate assembly's bolts 3b and/or flanged edges 3f, e.g. via a sliding/mounting action and providing sufficient clearance for said bolts 3b and/or flanged edges 3f (see FIGS. 9, 13, 14 and 15). More preferably, the top and the rear portions of the hopper side walls 10s (i.e. those wall portions at the rear end 10r, including any passages 10p) are dimensioned to substantially seal with the gate assembly 3 when the hopper 10 is placed in the mounted configuration, resulting in a rear sealed arrangement to prevent (or at least significantly reduce) any spillage or escape of granular materials from the rear 10r end of the hopper 10 during bin unloading operations (see FIGS. 2, 12 and 20-21). Even more preferably, the top edges of the generally opposite facing and parallel oriented sections of the hopper wall 10s are provided with a lip 10l to cover the shoulders 22s of the side members 22, and thereby further facilitate creation of the rear sealed arrangement when in the mounted configuration (see FIG. 15). Accordingly, when in the rear sealed arrangement, and because of the hopper's sloped configuration, all or substantially all of the granular materials that may exit from the gate assembly 3 during bin unloading operations will be directed into rear end 10r of the chamber 11.

Just prior to bin unloading operations the hopper 10 can be positioned in the mounted configuration (see FIGS. 2, 12 and 20-22), and an auger's inlet end 5i can then be placed through the open top at the front end 10f, preferably accommodated by the rest 12 (see FIGS. 1 and 2), resulting in a front restricted arrangement whereby the physical presence of the auger 5 in the chamber 11 restricts (or at least significantly reduces) any spillage or escape of granular materials from the front 10f end of the hopper 10 during bin unloading operations. Preferably, the lip 10l that covers the shoulders 22s of the side members 22 is provided all around the top edges of the hopper walls 10s, including at the front end 10f (see FIG. 11a). Advantageously, such lip 10l will further facilitate creation of the front restricted arrangement (when in the mounted configuration) and redirect any granular materials back into the chamber 11 that may otherwise spill over the wall edges. In another embodiment (not shown), the lip 10l portions at the front end 10f may be enlarged (relative to the lip 10l at the rear end 10r) so as to abut against an auger 5 that is placed within the chamber, thereby even further enhance the front restricted arrangement and/or create a front sealed arrangement around the auger 5.

Advantageously, the combination of the front restricted arrangement and the rear sealed arrangement will prevent or significantly reduce any granular materials spill over during bin unloading operations, including when the rate of free-flowing granular materials exiting the bin exceeds the rate at which the auger 5 can evacuate materials therefrom. In such an instance, the hopper 10 of the present invention will act like a gate assembly that is closed, i.e. preventing granular materials from exiting out the throat 2t.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. A hopper (10), for use with a grain bin (1) having a gate assembly (3) with lateral projections, the hopper comprising:
a concave shape;
a bottom (10b);
a plurality of hopper walls (10s) forming a chamber (11) with an open top (10t) for receiving granular materials from the gate assembly (3) and directing said granular material downward along the interior of the hopper walls (10s) to collect on the hopper's bottom 10b; and
a mounting member (20) positioned on the hopper walls (10s) adjacent the open top (10t);
wherein the mounting member (20) mounts the hopper (10) from the gate assembly's lateral projections.

2. The hopper (10) of claim 1 wherein the lateral projections are bolts (3b).

3. The hopper (10) of claim 1 wherein the lateral projections are flanged edges (3f).

4. The hopper (10) of claim 1 wherein the mounting member (20) further comprises two side members (22).

5. The hopper (10) of claim 4 wherein the two side members (22) are each positioned along generally opposite facing and parallel oriented sections of the hopper wall (10s).

6. The hopper (10) of claim 4 wherein the two side members (22) further comprises a cross member (26).

7. The hopper (10) of claim 6 wherein the side members (22) are maintained in a spaced relation by the cross member (26).

8. The hopper (10) of claim 6 wherein the side members (22) are maintained in a spaced relation by the hopper walls (10s).

9. The hopper (10) of claim 6 wherein the side members (22) are molded as an integral part of the hopper's wall (10s).

10. The hopper (10) of claim 4 wherein each of the two side members (22) further comprise:
a shoulder (22s); and
a sidewall mounting member (24).

11. The hopper (10) of claim 4 wherein each of the side members (22) have an L-shaped cross section defined by two legs, with one leg forming the shoulder (22s) and the other leg forming the sidewall mounting member (24).

12. The hopper (10) of claim 9 wherein the sidewall mounting member (24), of each of side members (22), facilitate connecting each of said side member (22) to the plurality of hopper walls (10s).

13. The hopper (10) of claim 12 wherein the sidewall mounting members (24) are connected to the generally opposite facing and parallel oriented sections of the hopper wall (10s).

14. The hopper (10) of claim 13 wherein the sidewall mounting members (24) are connected to the hopper wall (10s) at a distance (24d) apart from each other, within a width (10w) of the interior chamber (11).

15. The hopper (10) of claim 10 wherein each of the shoulders (22s) have a length (221) and a width (22w), wherein each of the shoulder (22s) further comprises an inner edge (22i, 22i′), and wherein the inner edges (22i, 22i′) further define an inside clearance distance (22d) therebetween.

16. The hopper (10) of claim 15 wherein the inside clearance distance (22d) is greater than a width (3w) of the gate assembly (3).

17. The hopper (10) of claim 16 wherein the inside clearance distance (22d) is less than a distance (3d) between ends (E) of the lateral projections.

18. The hopper (10) of claim 17 wherein the shoulders 22s are placeable upon the lateral projections when the hopper (10) is mounted from the gate assembly's lateral projections.

19. The hopper (10) of claim 18 wherein portions of the hopper side walls (10s) at a rear end (10r) of the hopper (10) will have sufficient clearance to facilitate mounting and removal of the hopper 10 on and off the gate assembly's lateral projections.
